(19) United States
(12) Patent Application Publication
(10) Pub. No.: US 2016/0191848 A1
(43) Pub. Date: Jun. 30, 2016

(54) MOTHERBOARD AND VIDEO SIGNAL SWITCHING CIRCUIT THEREOF

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: SONG GUO, Wuhan (CN)

(21) Appl. No.: 14/614,775

(22) Filed: Feb. 5, 2015

(30) Foreign Application Priority Data
Dec. 31, 2014 (CN) 201410846945.5

(51) Int. Cl. H04N 7/10; H04N 7/01

(52) U.S. Cl. CPC H04N 7/104; H04N 7/0125

(57) ABSTRACT

A motherboard includes a video signal switching circuit. The video signal switching circuit includes a video signal output unit, a video interface, a detecting unit, a control unit, and a signal conversion unit. The video signal output unit is used to output a first video signal. When the detecting unit detects that a first cable is connected to the video interface, the control unit outputs a first control signal to the signal conversion unit, the signal conversion unit does not operate, and the video interface receives the first video signal. When the detecting unit detects that a second cable is connected to the video interface, the control unit outputs a second control signal to the signal conversion unit, the signal conversion unit operates and converts the first video signal into a second video signal, and the video interface receives the second video signal.

### FIELD

The subject matter herein generally relates to motherboards and particularly to a motherboard with a video signal switching circuit.

### BACKGROUND

Generally, motherboards of electronic devices (such as computers and servers) can output different kinds of video signals (such as a high definition multimedia interface video signal and Displayport video signal). However, each video signal needs a video circuit and a video interface to be output, which wastes resources and occupies space of the motherboards.

### BRIEF DESCRIPTION OF THE DRAWINGS

Implementations of the present technology will now be described, by way of examples only, with reference to the attached figures.

FIG. 1 is a block diagram of an embodiment of a motherboard comprising a video signal switching circuit, wherein the video signal switching circuit comprises a video signal output unit, a video interface, a detecting unit, a control unit, a signal conversion unit, a channel signal output unit, and a channel signal transmission unit.

FIG. 2 is a circuit diagram of the detecting unit and the control unit of FIG. 1.

FIG. 3 is a circuit diagram of the video signal output unit, the video interface, and the signal conversion unit of FIG. 1.

FIG. 4 is a circuit diagram of the video interface, the channel signal output unit, and the channel signal transmission unit of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

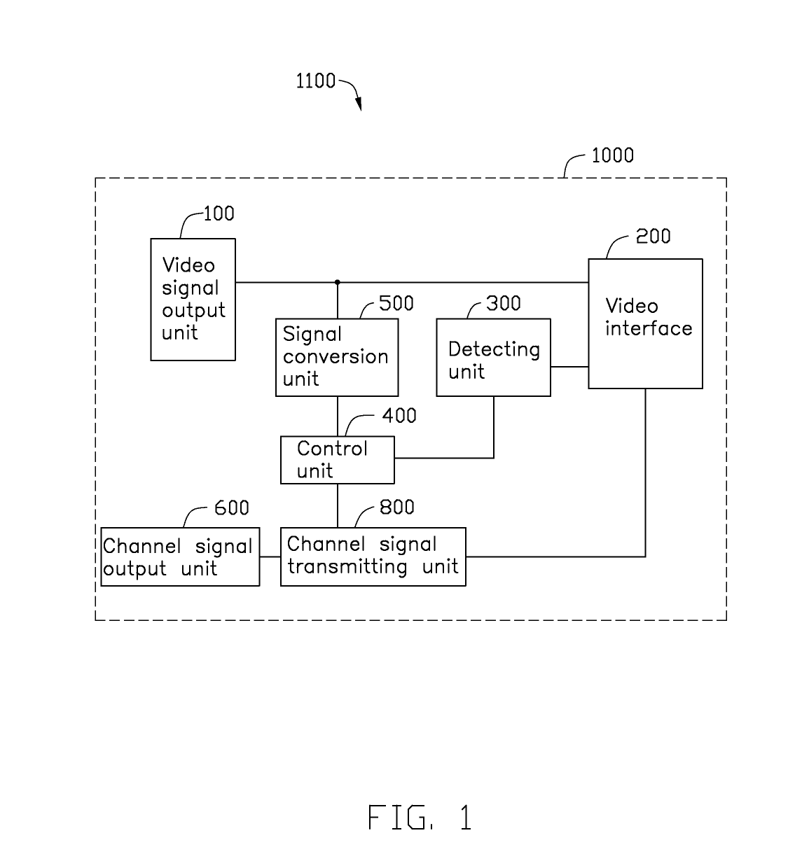

FIG. 1 illustrates an embodiment of a motherboard 1100. The motherboard 1100 can comprise a video signal switching unit 1000. The video signal switching unit 1000 can comprise a video signal output unit 100, a video interface 200, a detecting unit 300, a control unit 400, a signal conversion unit 500, a channel signal output unit 600, and a channel signal transmission unit 800. The video signal output unit 100 is electrically coupled to the video interface 200 and the signal conversion unit 500. The video interface 200 is electrically coupled to the control unit 400 via the detecting unit 300, and is electrically coupled to the channel signal output unit 600 via the channel signal transmission unit 800. The control unit 400 is electrically coupled to the signal conversion unit 500 and the channel signal transmission unit 800. The video signal output unit 100 is configured to output a first video signal. The channel signal output unit 600 is configured to output a first channel signal and a second channel signal. The detecting unit 300 is configured to detect the types of cables electrically coupled to the video interface 200, and output the detected results in accordance with the detected types of cables to the control unit 400. The control unit 400 is configured to control the signal conversion unit 500 to operate or not, and control the channel signal transmission unit 800 to transmit the first channel signal or the second channel signal, according to the detected results received from the detecting unit 300. The signal conversion unit 500 is configured to convert the first video signal into a second video signal.

In at least one embodiment, the video signal output unit 100 can be a central processing unit, the first video signal can be a DisplayPort video signal, and the second video signal can be a high definition multimedia interface (HDMI) video signal. The video interface 200 can be a DisplayPort. The channel signal output unit 600 can be a platform controller hub, the first channel signal can be a DisplayPort auxiliary channel signal DP AUX, and the second channel signal can be a HDMI display data channel signal HDMI DDC.

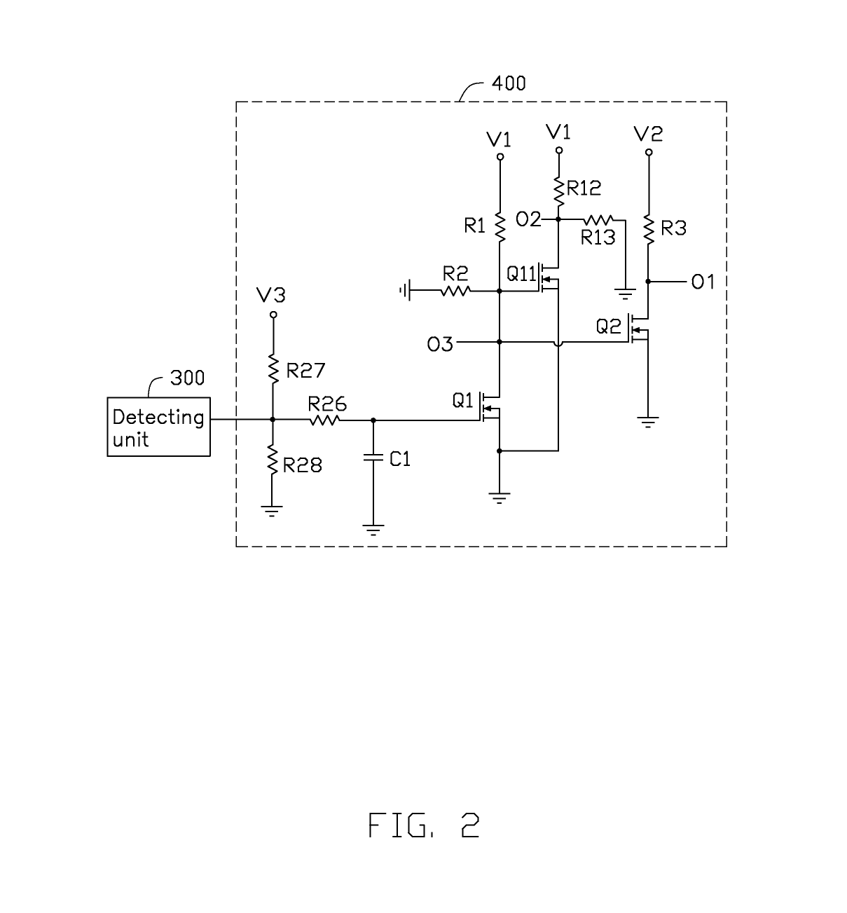

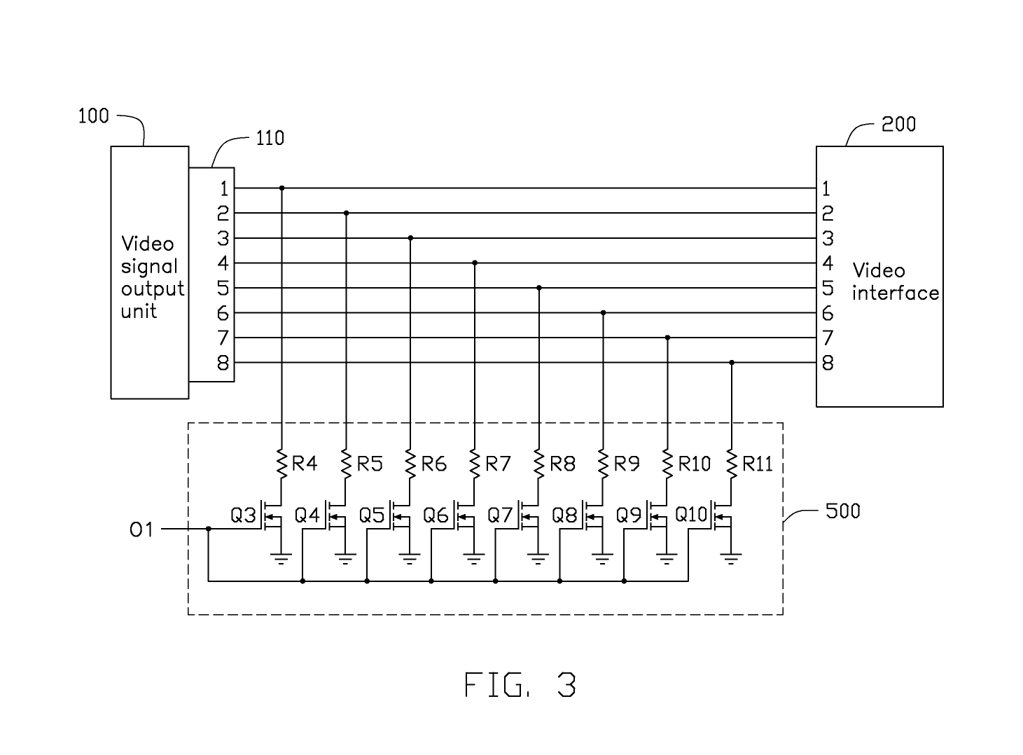

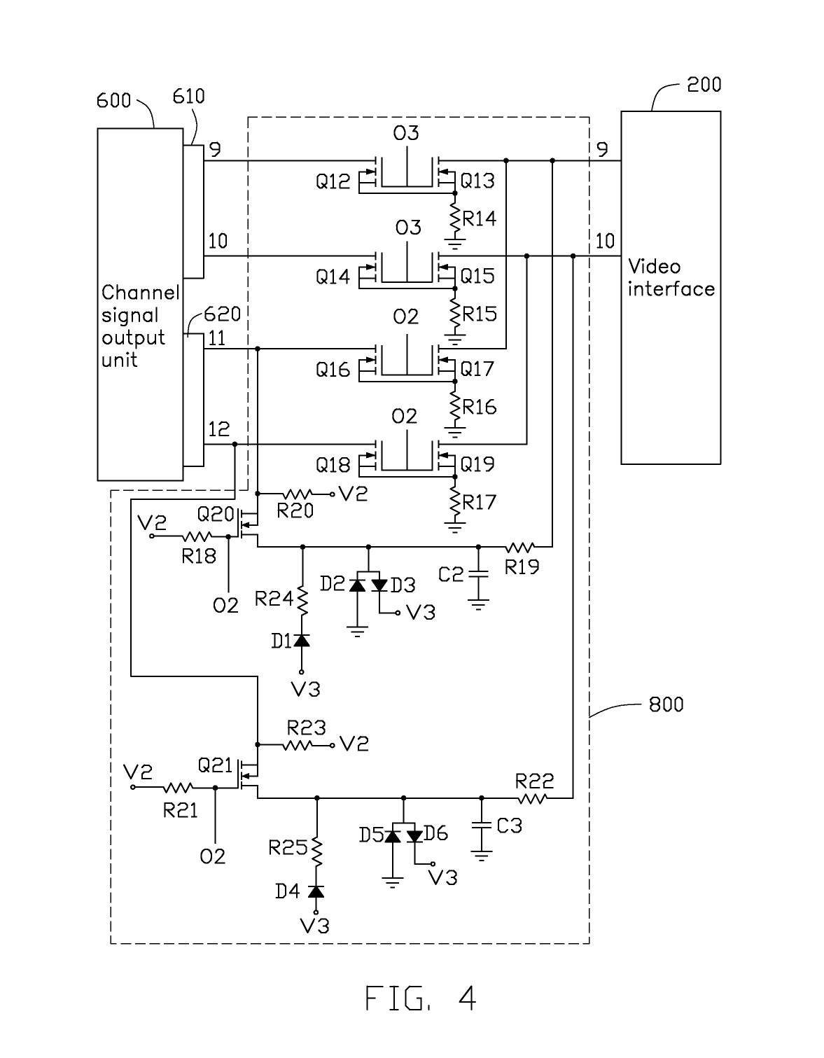

FIGS. 2-4 illustrate an embodiment of the video signal switching unit 1000. The control unit 400 can comprise three electronic switches Q1, Q2, and Q11, a capacitor C1, and eight resistors R1-R3, R12, R13, and R26-R28. Each of the electronic switches Q1, Q2, and Q11 can comprise a first terminal, a second terminal, and a third terminal. The first terminal of the electronic switch Q1 is electrically coupled to the detecting unit 300 through the resistor R26, electrically coupled to a ground through the capacitor C1, electrically coupled to a power supply V3 through the resistor R26 and the resistor R27 in that order, and electrically coupled to the ground through the resistor R26 and the resistor R28 in that order. The second terminal of the electronic switch Q1 is electrically coupled to a power supply V1 through the resistor R1, and electrically coupled the ground through the second resistor R2. The third terminal of the electronic switch Q1 is electrically coupled to the ground. The first terminal of the electronic switch Q2 is electrically coupled to the second terminal of the electronic switch Q1. The second terminal of the electronic switch Q2 is electrically coupled to a power supply V2 through the resistor R3. The third terminal of the electronic switch Q2 is electrically coupled to the ground. The first terminal of the electronic switch Q11 is electrically coupled to the second terminal of the electronic switch Q1. The second terminal of the electronic switch Q11 is electrically coupled to the power supply V1 through the resistor R12, and electrically coupled to the ground through the resistor R13. The third terminal of the electronic switch Q11 is electrically coupled to the ground. The second terminal of the electronic switch Q2 functioning as a first output terminal O1 of the control unit 400, is electrically coupled to the signal conversion unit 500. The second terminal of the electronic switch Q11 functioning as a second output terminal O2 of the control unit 400, is electrically coupled to the channel signal transmission unit 800. The second terminal of the electronic switch Q1 functioning as a third output terminal O3 of the control unit 400, is electrically coupled to the channel signal transmission unit 800.

The video signal output unit 100 can comprise an interface 110, and the interface 110 can comprise eight pins 1-8. The video interface 200 can comprise ten pins 1-10. The signal conversion unit 500 can comprise eight electronic switches Q3-Q10 and eight resistors R4-R11. Each of the electronic switches Q3-Q10 can comprise a first terminal, a second terminal, and a third terminal. The pins 1-8 of the interface 110 is electrically coupled to the pins 1-8 of the video interface 200. Each first terminal of the electronic switches Q3-Q10 is electrically coupled to the first output terminal O1 of the control unit 400. The second terminal of the electronic switch Q3 is electrically coupled to the pin 1 of the interface 110 through the resistor R4. The second terminal of the electronic switch Q4 is electrically coupled to the pin 2 of the interface 110 through the resistor R5. The second terminal of the electronic switch Q5 is electrically coupled to the pin 3 of the interface 110 through the resistor R6. The second terminal of the electronic switch Q6 is electrically coupled to the pin 4 of the interface 110 through the resistor R7. The second terminal of the electronic switch Q7 is electrically coupled to the pin 5 of the interface 110 through the resistor R8. The second terminal of the electronic switch Q8 is electrically coupled to the pin 6 of the interface 110 through the resistor R9. The second terminal of the electronic switch Q9 is electrically coupled to the pin 7 of the interface 110 through the resistor R10. The second terminal of the electronic switch Q10 is electrically coupled to the pin 8 of the interface 110 through the resistor R11. Each third terminal of the electronic switches Q3-Q10 is electrically coupled to the ground.

The channel signal output unit 600 can comprise two interfaces 610 and 620. The interface 610 can comprise two pins 9 and 10. The interface 620 can comprise two pins 11 and 12. The channel signal transmission unit 800 can comprise ten electronic switches Q12-Q21, twelve resistors R14-R25, six diodes D1-D6, and two capacitors C1 and C2.

Each of the electronic switches Q12-Q21 can comprise a first terminal, a second terminal, and a third terminal. Each first terminal of the electronic switches Q12-Q15 is electrically coupled to the third output terminal O3 of the control unit 400. The second terminal of the electronic switch Q12 is electrically coupled to the pin 9 of the interface 610. The third terminal of the electronic switch Q12 is electrically coupled to the ground through the resistor R14. The second terminal of the electronic switch Q13 is electrically coupled to the pin 9 of the video interface 200. The third terminal of the electronic switch Q13 is electrically coupled to the third terminal of the electronic switch Q12. The second terminal of the electronic switch Q14 is electrically coupled to the pin 10 of the interface 610. The third terminal of the electronic switch Q14 is electrically coupled to the ground through the resistor R15. The second terminal of the electronic switch Q15 is electrically coupled to the pin 10 of the video interface 200. The third terminal of the electronic switch Q15 is electrically coupled to the third terminal of the electronic switch Q14.

Each first terminal of the electronic switches Q16-Q19 is electrically coupled to the second output terminal O2 of the control unit 400. The second terminal of the electronic switch Q16 is electrically coupled to the pin 11 of the interface 620. The third terminal of the electronic switch Q16 is electrically coupled to the ground through the resistor R16. The second terminal of the electronic switch Q17 is electrically coupled to the pin 9 of the video interface 200. The third terminal of the electronic switch Q17 is electrically coupled to the third terminal of the electronic switch Q16. The second terminal of the electronic switch Q18 is electrically coupled to the pin 12 of the interface 620. The third terminal of the electronic switch Q18 is electrically coupled to the ground through the resistor R17. The second terminal of the electronic switch Q19 is electrically coupled to the pin 10 of the video interface 200. The third terminal of the electronic switch Q19 is electrically coupled to the third terminal of the electronic switch Q18.

The first terminal of the electronic switch Q20 is electrically coupled to the second output terminal O2 of the control unit 400, and electrically coupled to the power supply V2 through the resistor R18. The second terminal of the electronic switch Q20 is electrically coupled to the pin 9 of the video interface 200 through the resistor R19, and is electrically coupled to the ground through the capacitor C2. The third terminal of the electronic switch Q20 is electrically coupled to the pin 11 of the interface 620, and is electrically coupled to the power supply V2 through the resistor R20. The first terminal of electronic switch Q21 is electrically coupled to the second output terminal O2 of the control unit 400, and electrically coupled to the power supply V2 through the resistor R21. The second terminal of the electronic switch Q21 is electrically coupled to the pin 10 of the video interface 200 through the resistor R22, and is electrically coupled to the ground through the capacitor C3. The third terminal of the electronic switch Q21 is electrically coupled to the pin 12 of the interface 620, and is electrically coupled to the power supply V2 through the resistor R23.

An anode of the diode D1 is electrically coupled to the power supply V3. A cathode of the diode D1 is electrically coupled to the second terminal of the electronic switch Q20 through the resistor R24. An anode of the diode D2 is electrically coupled to the ground. A cathode of the diode D2 is electrically coupled to the second terminal of the electronic switch Q20. An anode of the diode D3 is electrically coupled to the cathode of the diode D2. A cathode of the diode D3 is electrically coupled to the power supply V3. An anode of the diode D4 is electrically coupled to the power supply V3. A cathode of the diode D4 is electrically coupled to the second terminal of the electronic switch Q21 through the resistor R25. An anode of the diode D5 is electrically coupled to the ground. A cathode of the diode D5 is electrically coupled to the second terminal of the electronic switch Q21. An anode of the diode D6 is electrically coupled to the cathode of the diode D5. A cathode of the diode D6 is electrically coupled to the power supply V3.

In operation, the video signal output unit 100 outputs the first video signal through the pins 1-8 of the interface 110. The channel signal output unit 600 outputs the first channel signal through the pins 9 and 10 of the interface 610, and outputs the second channel signal through the pins 11 and 12 of the interface 620. The detecting unit 300 detects the type of cables electrically coupled to the video interface 200, and outputs the detected result to the control unit 400.

When the detecting unit 300 detects that a first cable is electrically coupled to the video interface 200, the detecting unit 300 outputs a low level signal, such as a logic 0 signal. The electronic switch Q1 is turned off, and the electronic switches Q2 and Q11 are turned on. The first output terminal O1 of the control unit 400 outputs a low level signal, such as a logic 0 signal, the second output terminal O2 of the control unit 400 outputs a low level signal, such as a logic 0 signal, and the third output terminal O3 of the control unit 400 outputs a high level signal, such as a logic 1 signal.

When the first terminals of the electronic switches Q3-Q11 receive the low level signal from the first output terminal O1 of the control unit 400, the electronic switches Q3-Q11 are turned off, and the pins 1-8 of the video interface 200 receive the first video signal from the pins 1-8 of the interface 110.

When the first terminals of the electronic switches Q12-Q15 receive the high level signal from the third output terminal O3 of the control unit 400, the electronic switches Q12-Q15 are turned on. The first channel signal output from the pin 9 of the interface 610 is transmitted to the pin 9 of the video interface 200 through the electronic switches Q12 and Q13, and first channel signal output from the pin 10 of the interface 610 is transmitted to the pin 10 of the video interface 200 through the electronic switches Q14 and Q15.

When the first terminals of the electronic switches Q16-Q21 receive the low level signal from the second output terminal O2 of the control unit 400, the electronic switches Q16-Q21 are turned off. The second channel signal output from the pins 11 and 12 of the interface 620 cannot be transmitted to the pins 9 and 10 of the video interface 200 through the electronic switches Q16-Q21.

When the detecting unit 300 detects that a second cable is electrically coupled to the video interface 200, the detecting unit 300 outputs a high level signal, such as a logic 1. The electronic switch Q1 is turned on, and the electronic switches Q2 and Q11 are turned off. The first output terminal O1 of the control unit 400 outputs a high level signal, such as a logic 1 signal, the second output terminal O2 of the control unit 400 outputs a high level signal, such as a logic 1 signal, and the third output terminal O3 of the control unit 400 outputs a low level signal, such as a logic 0 signal.

When the first terminals of the electronic switches Q3-Q11 receive the high level signal from the first output terminal O1 of the control unit 400, the electronic switches Q3-Q11 are turned on. Voltages of the first video signal output from the pins 1-8 of the interface 110 are divided by the resistors R4-R11, therefore, the first video signal is converted into the second video signal by the signal conversion unit 500, and the pins 1-8 of the video interface 200 receive the second video signal.

When the first terminals of the electronic switches Q16-Q21 receive the high level signal from the second output terminal O2 of the control unit 400, the electronic switches Q16-Q21 are turned on. The second channel signal output from the pin 11 of the interface 620 is transmitted to the pin 9 of the video interface 200 through the electronic switches Q16 and Q17, and is transmitted to the pin 9 of the video interface 200 through the electronic switch Q20 and the resistor R19. The second channel signal output from the pin 12 of the interface 620 is transmitted to the pin 10 of the video interface 200 through the electronic switches Q18 and Q19, and is transmitted to the pin 10 of the video interface 200 through the electronic switch Q21 and the resistor R22.

When the first terminals of the electronic switches Q12-Q15 receive the low level signal from the third output terminal O3 of the control unit 400, the electronic switches Q12-Q15 are turned off. The first channel signal output from the pins 9 and 10 of the interface 610 cannot be transmitted to the pins 9 and 10 of the video interface 200 through the electronic switches Q12-Q15.

In at least one embodiment, each of the electronic switches Q1-Q21 can be an re-channel metal-oxide semiconductor field-effect transistor (NMOSFET), and the first terminal, the second terminal, and the third terminal of each of the electronic switches Q1-Q21 correspond to a gate, a drain, and a source of the NMOSFET, respectively. The first cable is a cable configured to transmit the DisplayPort video signal. The second cable is a cable configured to transmit the HDMI video signal. The power supply V1 is a 19V power supply, the power supply V2 is a 3V power supply, and the power supply V3 is a 5V power supply. In other embodiments, each of the electronic switches Q1 -Q21 can be an npn-type bipolar junction transistor or other suitable switch having similar functions.

The embodiment shown and described above is only an example. Many details are often found in the art such as the other features of the motherboard. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiment described above may be modified within the scope of the claims.

What is claimed is:

1. A video signal switching circuit comprising:
a video interface;
a detecting unit electrically coupled to the video interface, and configured to detect types of cables electrically coupled to the video interface and output detected results in accordance with the detected types of cables;
a video signal output unit electrically coupled to the video interface, and configured to output a first video signal;
a signal conversion unit electrically coupled to the video interface and the video signal output unit, and configured to convert the first video signal into a second video signal; and
a control unit electrically coupled to the detecting unit to receive the detected results, and electrically coupled to the signal conversion unit to output control signals to the signal conversion unit according to the detected results received from the detecting unit;
the video signal switching circuit configured such that, in response to the detecting unit's detecting that a first cable is electrically coupled to the video interface, the detecting unit outputs a first detected result to the control unit, the control unit outputs a first control signal to the signal conversion unit, the signal conversion unit does not operate, and the video interface receives the first video signal; and in response to the detecting unit's detecting that a second cable is electrically coupled to the video interface, the detecting unit outputs a second detected result to the control unit, the control unit outputs a second control signal to the signal conversion unit, the signal conversion unit operates and converts the first video signal into a second video signal, and the video interface receives the second video signal.

2. The video signal switching circuit of claim 1, wherein the control unit comprises:
a first resistor, a second resistor, and a third resistor;
a first electronic switch comprising a first terminal electrically coupled to the detecting unit to receive the detected results, a second terminal electrically coupled to a first power supply through the first resistor and electrically coupled to a ground through the second resistor, and a third terminal electrically coupled to the ground; and
a second electronic switch comprising a first terminal electrically coupled to the second terminal of the first electronic switch, a second terminal functioning as a first output terminal of the control unit and electrically coupled to a second power supply through the third resistor, and a third terminal electrically coupled to the ground;
wherein in response to the detecting unit's detecting that the first cable is electrically coupled to the video interface, the detecting unit outputs the first detect result to the first terminal of the first electronic switch, the first electronic switch is turned off, the second electronic switch is turned on, and the first output terminal of the control unit outputs the first control signal; and in response to the detecting unit's detecting that the second cable is electrically coupled to the video interface, the detecting unit outputs the second detect result to the first terminal of the first electronic switch, the first electronic switch is turned on, the second electronic switch is turned off, and the first output terminal of the control unit outputs the second control signal.

3. The video signal switching circuit of claim 2, wherein the video signal output unit comprises a first interface comprising first to eighth pins configured to output the first video signal, the video interface comprises first to eighth pins electrically coupled to the first to eighth pins of the first interface, and the signal conversion unit comprises:
fourth to eleventh resistors;
a third electronic switch comprising a first terminal electrically coupled to the first output terminal of the control unit, a second terminal electrically coupled to the first pin of the first interface through the fourth resistor, and a third terminal electrically coupled to the ground;
a fourth electronic switch comprising a first terminal electrically coupled to the first output terminal of the control unit, a second terminal electrically coupled to the second pin of the first interface through the fifth resistor, and a third terminal electrically coupled to the ground;
a fifth electronic switch comprising a first terminal electrically coupled to the first output terminal of the control unit, a second terminal electrically coupled to the third pin of the first interface through the sixth resistor, and a third terminal electrically coupled to the ground;
a sixth electronic switch comprising a first terminal electrically coupled to the first output terminal of the control unit, a second terminal electrically coupled to the fourth pin of the first interface through the seventh resistor, and a third terminal electrically coupled to the ground;
a seventh electronic switch comprising a first terminal electrically coupled to the first output terminal of the control unit, a second terminal electrically coupled to the fifth pin of the first interface through the eighth resistor, and a third terminal electrically coupled to the ground;
an eighth electronic switch comprising a first terminal electrically coupled to the first output terminal of the control unit, a second terminal electrically coupled to the sixth pin of the first interface through the ninth resistor, and a third terminal electrically coupled to the ground;
a ninth electronic switch comprising a first terminal electrically coupled to the first output terminal of the control unit, a second terminal electrically coupled to the seventh pin of the first interface through the tenth resistor, and a third terminal electrically coupled to the ground; and
a tenth electronic switch comprising a first terminal electrically coupled to the first output terminal of the control unit, a second terminal electrically coupled to the eighth pin of the first interface through the eleventh resistor, and a third terminal electrically coupled to the ground;
wherein in response to the first output terminal of the control unit outputting the first control signal, the third to tenth electronic switches are turned off, and the first to eighth pins of the video interface receive the first video signal; and
wherein in response to the first output terminal of the control unit outputting the second control signal, the third to tenth electronic switches are turned on, voltages of the first video signal output from the first to eighth pins of the first interface are divided by the fourth to eleventh resistors, thus the first video signal is converted into the second video signal by the signal conversion unit, and the first to eighth pins of the video interface receive the second video signal.

4. The video signal switching circuit of claim 2, further comprising:
a channel signal output unit comprising a second interface to output a first channel signal and a third interface to output a second channel signal; and
a channel signal transmission unit;
wherein the control unit further comprises:
a twelfth resistor and a thirteenth resistor; and
an eleventh electronic switch comprising a first terminal electrically coupled to the second terminal of the first electronic switch, a second terminal functioning as a second output terminal of the control unit, electrically coupled to the channel signal transmission unit, electrically coupled to the first power supply through the twelfth resistor, and electrically coupled to the ground through the thirteenth resistor, and a third terminal electrically couple to the ground;
wherein the second terminal of the first electronic switch functioning as a third output terminal of the control unit is electrically coupled to the channel signal transmission unit, and the channel signal transmission unit is electrically coupled to the second interface, the third interface, and the video interface;
wherein in response to the detecting unit's detecting that the first cable is electrically coupled to the video interface, the first electronic switch is turned off, the eleventh electronic switch is turned on, the second output terminal of the control unit outputs a third control signal to the channel signal transmission unit, the third output terminal of the control unit outputs a fourth control signal to the channel signal transmission unit, and the channel signal transmission unit transmits the first channel signal output from the second interface to the video interface; and
wherein in response to the detecting unit's detecting that the second cable is electrically coupled to the video interface, the first electronic switch is turned on, the eleventh electronic switch is turned off, the second output terminal of the control unit outputs a fifth control signal to the channel signal transmission unit, the third output terminal of the control unit outputs a sixth control signal to the channel signal transmission unit, and the channel signal transmission unit transmits the second channel signal output from the third interface to the video interface.

5. The video signal switching circuit of claim 4, wherein the second interface comprises a ninth pin and a tenth pin, the third interface comprises an eleventh pin and a twelfth pin, the video interface further comprises a ninth pin and a tenth pin, and the channel signal transmission unit comprises:
fourteenth to seventeenth resistors;
a twelfth electronic switch comprising a first terminal electrically coupled to the third output terminal of the control unit, a second terminal electrically coupled to the ninth pin of the second interface, and a third terminal electrically coupled to the ground through the fourteenth resistor; and
a thirteenth electronic switch comprising a first terminal electrically coupled to the third output terminal of the control unit, a second terminal electrically coupled to the ninth pin of the video interface, and a third terminal electrically coupled to the third terminal of the twelfth electronic switch;
a fourteenth electronic switch comprising a first terminal electrically coupled to the third output terminal of the control unit, a second terminal electrically coupled to the tenth pin of the second interface, and a third terminal electrically coupled to the ground through the fifteenth resistor; and
a fifteenth electronic switch comprising a first terminal electrically coupled to the third output terminal of the control unit, a second terminal electrically coupled to the tenth pin of the video interface, and a third terminal electrically coupled to the third terminal of the fourteenth electronic switch;
a sixteenth electronic switch comprising a first terminal electrically coupled to the second output terminal of the control unit, a second terminal electrically coupled to the eleventh pin of the third interface, and a third terminal electrically coupled to the ground through the sixteenth resistor; and
a seventeenth electronic switch comprising a first terminal electrically coupled to the second output terminal of the control unit, a second terminal electrically coupled to the ninth pin of the video interface, and a third terminal electrically coupled to the third terminal of the sixteenth electronic switch;
an eighteenth electronic switch comprising a first terminal electrically coupled to the second output terminal of the control unit, a second terminal electrically coupled to the twelfth pin of the third interface, and a third terminal electrically coupled to the ground through the seventeenth resistor; and
a nineteenth electronic switch comprising a first terminal electrically coupled to the second output terminal of the control unit, a second terminal electrically coupled to the tenth pin of the video interface, and a third terminal electrically coupled to the third terminal of the eighteenth electronic switch;
a twentieth electronic switch comprising a first terminal electrically coupled to the second output terminal of the control unit, a second terminal electrically coupled to the ninth pin of the video interface, and a third terminal electrically coupled to the eleventh pin of the third interface; and
a twenty-first electronic switch comprising a first terminal electrically coupled to the second output terminal of the control unit, a second terminal electrically coupled to the tenth pin of the video interface, and a third terminal electrically coupled to the twelfth pin of the third interface;
wherein in response to the second output terminal of the control unit outputting the third control signal and the third output terminal of the control unit outputting the fourth control signal, the twelfth to the fifteenth electronic switches are turned on, the sixteenth to twenty-first electronic switches are turned off, the first channel signal output from the ninth pin of the second interface is transmitted to the ninth pin of the video interface through the twelfth and the thirteenth electronic switches, and the first channel signal output from the tenth pin of the second interface is transmitted to the tenth pin of the video interface through the fourteenth and the fifteenth electronic switches; and
wherein in response to the second output terminal of the control unit outputting the fifth control signal and the third output terminal of the control unit outputting the sixth control signal, the twelfth to the fifteenth electronic switches are turned off, the sixteenth to twenty-first electronic switches are turned on, the second channel signal output from the eleventh pin of the third interface is transmitted to the ninth pin of the video interface through the sixteenth and the seventeenth electronic switches, and is transmitted to the ninth pin of the video interface through the twentieth electronic switch, and the second channel signal output from the twelfth pin of the third interface is transmitted to the tenth pin of the video interface through the eighteenth and the nineteenth electronic switches, and is transmitted to the tenth pin of the video interface through the twenty-first electronic switch.

6. A motherboard comprising:
a video signal switching circuit comprising:
a video interface;
a detecting unit electrically coupled to the video interface, and configured to detect types of cables electrically coupled to the video interface and output detected results in accordance with the detected types of cables;
a video signal output unit electrically coupled to the video interface, and configured to output a first video signal;
a signal conversion unit electrically coupled to the video interface and the video signal output unit, and configured to convert the first video signal into a second video signal; and
a control unit electrically coupled to the detecting unit to receive the detected results, and electrically coupled to the signal conversion unit to output control signals to the signal conversion unit according to the detected results received from the detecting unit;
the video signal switching circuit configured such that, in response to the detecting unit's detecting that a first cable is electrically coupled to the video interface, the detecting unit outputs a first detected result to the control unit, the control unit outputs a first control signal to the signal conversion unit, the signal conversion unit does not operate, and the video interface receives the first video signal; and in response to the detecting unit's detecting that a second cable is electrically coupled to the video interface, the detecting unit outputs a second detected result to the control unit, the control unit outputs a second control signal to the signal conversion unit, the signal conversion unit operates and converts the first video signal into a second video signal, and the video interface receives the second video signal.

7. The motherboard of claim 6, wherein the control unit comprises:
a first resistor, a second resistor, and a third resistor;
a first electronic switch comprising a first terminal electrically coupled to the detecting unit to receive the detected results, a second terminal electrically coupled to a first power supply through the first resistor and electrically coupled to a ground through the second resistor, and a third terminal electrically coupled to the ground; and
a second electronic switch comprising a first terminal electrically coupled to the second terminal of the first electronic switch, a second terminal functioning as a first output terminal of the control unit and electrically coupled to a second power supply through the third resistor, and a third terminal electrically coupled to the ground;
wherein in response to the detecting unit's detecting that the first cable is electrically coupled to the video interface, the detecting unit outputs the first detect result to the first terminal of the first electronic switch, the first electronic switch is turned off, the second electronic switch is turned on, and the first output terminal of the control unit outputs the first control signal; and in response to the detecting unit's detecting that the second cable is electrically coupled to the video interface, the detecting unit outputs the second detect result to the first terminal of the first electronic switch, the first electronic switch is turned on, the second electronic switch is turned off, and the first output terminal of the control unit outputs the second control signal.

8. The motherboard of claim 7, wherein the video signal output unit comprises a first interface comprising first to eighth pins configured to output the first video signal, the video interface comprises first to eighth pins electrically coupled to the first to eighth pins of the first interface, and the signal conversion unit comprises:
fourth to eleventh resistors;
a third electronic switch comprising a first terminal electrically coupled to the first output terminal of the control unit, a second terminal electrically coupled to the first pin of the first interface through the fourth resistor, and a third terminal electrically coupled to the ground;
a fourth electronic switch comprising a first terminal electrically coupled to the first output terminal of the control unit, a second terminal electrically coupled to the second pin of the first interface through the fifth resistor, and a third terminal electrically coupled to the ground;
a fifth electronic switch comprising a first terminal electrically coupled to the first output terminal of the control unit, a second terminal electrically coupled to the third pin of the first interface through the sixth resistor, and a third terminal electrically coupled to the ground;
a sixth electronic switch comprising a first terminal electrically coupled to the first output terminal of the control unit, a second terminal electrically coupled to the fourth pin of the first interface through the seventh resistor, and a third terminal electrically coupled to the ground;
a seventh electronic switch comprising a first terminal electrically coupled to the first output terminal of the control unit, a second terminal electrically coupled to the fifth pin of the first interface through the eighth resistor, and a third terminal electrically coupled to the ground;
an eighth electronic switch comprising a first terminal electrically coupled to the first output terminal of the control unit, a second terminal electrically coupled to the sixth pin of the first interface through the ninth resistor, and a third terminal electrically coupled to the ground;
a ninth electronic switch comprising a first terminal electrically coupled to the first output terminal of the control unit, a second terminal electrically coupled to the seventh pin of the first interface through the tenth resistor, and a third terminal electrically coupled to the ground; and
a tenth electronic switch comprising a first terminal electrically coupled to the first output terminal of the control unit, a second terminal electrically coupled to the eighth pin of the first interface through the eleventh resistor, and a third terminal electrically coupled to the ground;
wherein in response to the first output terminal of the control unit outputting the first control signal, the third to tenth electronic switches are turned off, and the first to eighth pins of the video interface receive the first video signal; and
wherein in response to the first output terminal of the control unit outputting the second control signal, the third to tenth electronic switches are turned on, voltages of the first video signal output from the first to eighth pins of the first interface are divided by the fourth to eleventh resistors, thus the first video signal is converted into the second video signal by the signal conversion unit, and the first to eighth pins of the video interface receive the second video signal.

9. The motherboard of claim 7, wherein the video signal switching circuit further comprises:
a channel signal output unit comprising a second interface to output a first channel signal and a third interface to output a second channel signal; and
a channel signal transmission unit;
wherein the control unit further comprises:
a twelfth resistor and a thirteenth resistor; and
an eleventh electronic switch comprising a first terminal electrically coupled to the second terminal of the first electronic switch, a second terminal functioning as a second output terminal of the control unit, electrically coupled to the channel signal transmission unit, electrically coupled to the first power supply through the twelfth resistor, and electrically coupled to the ground through the thirteenth resistor, and a third terminal electrically couple to the ground;
wherein the second terminal of the first electronic switch functioning as a third output terminal of the control unit is electrically coupled to the channel signal transmission unit, and the channel signal transmission unit is electrically coupled to the second interface, the third interface, and the video interface;
wherein in response to the detecting unit's detecting that the first cable is electrically coupled to the video interface, the first electronic switch is turned off, the eleventh electronic switch is turned on, the second output terminal of the control unit outputs a third control signal to the channel signal transmission unit, the third output terminal of the control unit outputs a fourth control signal to the channel signal transmission unit, and the channel signal transmission unit transmits the first channel signal output from the second interface to the video interface; and
wherein in response to the detecting unit's detecting that the second cable is electrically coupled to the video interface, the first electronic switch is turned on, the eleventh electronic switch is turned off, the second output terminal of the control unit outputs a fifth control signal to the channel signal transmission unit, the third output terminal of the control unit outputs a sixth control signal to the channel signal transmission unit, and the channel signal transmission unit transmits the second channel signal output from the third interface to the video interface.

10. The motherboard of claim 9, wherein the second interface comprises a ninth pin and a tenth pin, the third interface comprises an eleventh pin and a twelfth pin, the video interface further comprises a ninth pin and a tenth pin, and the channel signal transmission unit comprises:
fourteenth to seventeenth resistors;
a twelfth electronic switch comprising a first terminal electrically coupled to the third output terminal of the control unit, a second terminal electrically coupled to the ninth pin of the second interface, and a third terminal electrically coupled to the ground through the fourteenth resistor; and
a thirteenth electronic switch comprising a first terminal electrically coupled to the third output terminal of the control unit, a second terminal electrically coupled to the ninth pin of the video interface, and a third terminal electrically coupled to the third terminal of the twelfth electronic switch;
a fourteenth electronic switch comprising a first terminal electrically coupled to the third output terminal of the control unit, a second terminal electrically coupled to the tenth pin of the second interface, and a third terminal electrically coupled to the ground through the fifteenth resistor; and
a fifteenth electronic switch comprising a first terminal electrically coupled to the third output terminal of the control unit, a second terminal electrically coupled to the tenth pin of the video interface, and a third terminal electrically coupled to the third terminal of the fourteenth electronic switch;
a sixteenth electronic switch comprising a first terminal electrically coupled to the second output terminal of the control unit, a second terminal electrically coupled to the eleventh pin of the third interface, and a third terminal electrically coupled to the ground through the sixteenth resistor; and
a seventeenth electronic switch comprising a first terminal electrically coupled to the second output terminal of the control unit, a second terminal electrically coupled to the ninth pin of the video interface, and a third terminal electrically coupled to the third terminal of the sixteenth electronic switch;
an eighteenth electronic switch comprising a first terminal electrically coupled to the second output terminal of the control unit, a second terminal electrically coupled to the twelfth pin of the third interface, and a third terminal electrically coupled to the ground through the seventeenth resistor; and
a nineteenth electronic switch comprising a first terminal electrically coupled to the second output terminal of the control unit, a second terminal electrically coupled to the tenth pin of the video interface, and a third terminal electrically coupled to the third terminal of the eighteenth electronic switch;
a twentieth electronic switch comprising a first terminal electrically coupled to the second output terminal of the control unit, a second terminal electrically coupled to the ninth pin of the video interface, and a third terminal electrically coupled to the eleventh pin of the third interface; and
a twenty-first electronic switch comprising a first terminal electrically coupled to the second output terminal of the control unit, a second terminal electrically coupled to the tenth pin of the video interface, and a third terminal electrically coupled to the twelfth pin of the third interface;
wherein in response to the second output terminal of the control unit outputting the third control signal and the third output terminal of the control unit outputting the fourth control signal, the twelfth to the fifteenth electronic switches are turned on, the sixteenth to twenty-first electronic switches are turned off, the first channel signal output from the ninth pin of the second interface is transmitted to the ninth pin of the video interface through the twelfth and the thirteenth electronic switches, the first channel signal output from the tenth pin of the second interface is transmitted to the tenth pin of the video interface through the fourteenth and the fifteenth electronic switches; and
wherein in response to the second output terminal of the control unit outputting the fifth control signal and the third output terminal of the control unit outputting the sixth control signal, the twelfth to the fifteenth electronic switches are turned off, the sixteenth to twenty-first electronic switches are turned on, the second channel signal output from the eleventh pin of the third interface is transmitted to the ninth pin of the video interface through the sixteenth and the seventeenth electronic switches, and is transmitted to the ninth pin of the video interface through the twentieth electronic switch, and the second channel signal output from the twelfth pin of the third interface is transmitted to the tenth pin of the video interface through the eighteenth and the nineteenth electronic switches, and is transmitted to the tenth pin of the video interface through the twenty-first electronic switch.
